(19) United States
(12) Patent Application Publication
(10) Pub. No.: US 2007/0034041 A1
(43) Pub. Date: Feb. 15, 2007

(54) Shift-by-wire gearshift device

(75) Inventors: Marc Dominguis Botella, Gelida (ES); Javier Moreno Colom, Malla (ES)

Correspondence Address: HENSLEY KIM & EDGINGTON, LLC, 1660 LINCOLN STREET, SUITE 3050, DENVER, CO, 80264, US

(73) Assignee: FICO TRIAD, S.A.

(21) Appl. No.: 11/501,945

(22) Filed: Aug. 9, 2006

(30) Foreign Application Priority Data
Aug. 10, 2005 (EP) EP05107368.2

(51) Int. Cl. G05G 1/04

(52) U.S. Cl. 74/523

(57) ABSTRACT

The present devices include a selector lever operable by a user for remotely controlling a motor vehicle transmission, a biasing element to maintain one end of said selector lever in contact with a contoured surface for providing the user with a shifting feeling, and a detector element comprising an emitting element and a receiving element, one of which is attached to said end of the selector lever such that the position of the end of the selector lever on said contoured surface can be detected.

### CROSS-REFERENCE TO RELATED APPLICATIONS

The present invention claims priority from European Patent Application Number EP05107368, filed 10 Aug. 2005, entitled “Shift-by-wire gearshift device”; the subject matter of which hereby being specifically incorporated herein by reference for all that it discloses and teaches.

### FIELD OF THE INVENTION

The present invention relates to a shift-by-wire gearshift device comprising a selector lever operable by a user for remotely controlling a motor vehicle transmission. A biasing element is provided to maintain one end of the selector lever in contact with a contoured surface for providing the user with a shifting feeling. Also provided is a detector element comprising an emitting element and a receiving element.

### BACKGROUND ART

Drive-by-wire technology is currently known, for example, in latest generation transmission systems (shift-by-wire devices) in which conventional mechanical link (usually a cable) between two elements is replaced by electronic link. In the case of shift-by-wire devices, an electronic link is provided between the selector lever and the transmission of the motor vehicle. In electronic gear operation, a gear shift is requested by the driver using the selector lever. A detector element informs a control unit of the requested gear shift. Such. request is processed by a control unit and a command signal is sent for actuating the clutch and the gear sequence according to the driver's request.

Some shift-by-wire devices combine the above mentioned detector element with means for providing the driver with the desired shift feeling as if it is a mechanical shifting device. Said feeling means may comprise a biasing element acting on a follower member so that it is in contact with a contoured surface.

One of such devices is disclosed in U.S. Pat. No. 4,912,997, in which the shift selector mechanism includes detection and feeling features. In this case, the feeling feature is provided by a follower provided at the lower end of a selector lever for pre-loaded travel on a single cam track supported longitudinally on a rocker. The cam track is contoured to simulate shift effort and feel of conventional manual gear shifting operations. The detection feature is carried out by indicators operative for transmitting shift-by-wire signals to actuators thereby executing desired transmission gear selections. Position indicators are located on each rocker pivot axis and continuously monitor the rotational travel of each rocker pivot pin about its axis. A control module receives signals generated by the position indicators and incorporates memory and computer means adapted to indicate the instantaneous position of the follower as it is moved in the selected shift plane of the cam track. The indicators consist of two separate electrical angular position sensors (rotary angle instrument sensors) provided on a longitudinal axis and on a transverse axis.

Another example of shifting device for motor vehicle transmission is disclosed in U.S. Pat. No. 5,852,953, in which a gearshift lever is coupled with a control lug forming part of detector elements having separate sensors. The control lug reflects a signal which is sent as a signal corresponding to the shift position of the gearshift lever to a control unit of the transmission. The feeling means comprises contoured surfaces over which the lower end of the lever is guided through spring-loaded rollers for simulating the positive feel of a conventional mechanical gearchange.

Yet another gear shifting apparatus combining both feeling and detecting features is disclosed in U.S. Pat. No. 5,540,114. Detection is carried out by means of photo-sensor arrangements rotatably engaged with a shift shaft and a select shaft for detecting a position of a shift lever, and a cam arrangement coupled to the shift shaft for completing a shifting operation of the shift lever in case of a half shifting and providing a shifting feeling to a driver. The feeling means comprises a ball urged by a spring over a recessed groove formed on a housing lower plate. A cam is fixed to one end of the shift shaft, and a roller is rotatably contacted with said cam. In the shifting operation, an electric signal corresponding to a position of the shift lever is output to a control unit from an optical sensor device.

In the above mentioned prior art shift-by-wire gearshift devices feeling and detection features are carried out separately. Furthermore, the detection feature in prior art devices is performed by separate sensors which do not form part of the selector lever, thus making the assembly more complex and cumbersome.

### SUMMARY OF THE INVENTION

The present invention provides a shift-by-wire gearshift device that is simpler and more compact than prior art gearshift devices. This is accomplished by providing a detector element comprising an emitting element and a receiving element. The emitting element or the receiving element is attached to the end of the selector lever for detecting the position of the selector lever end on a contoured surface. In a preferred embodiment of the invention, the emitting element is the one fitted in the selector lever end.

The detector element works in combination with the above mentioned feeling or a haptic feature which, as stated below, is carried out through a biasing element which maintains one end of the selector lever in contact with a contoured surface. Therefore, the selector lever end itself performs two functions, that is, to provide the shifting feeling to the user and to detect the lever position relative to the contoured surface. This contoured surface may be any suitable surface, for example, a 3D-relief surface, a non-flat or irregular surface having channels or grooves where the selector lever passes.

In some embodiments of the shift-by-wire gearshift device of the invention, the detector element works with a magnetic field in which case the emitting element comprises a magnet which may be overmolded within the selector lever end.

According to a further embodiment of the shift-by-wire gearshift device, the receiving element of said detector element includes an electronic board that is fitted adjacent to said contoured surface, for example below said surface. The electronic board may be provided with sensors, such as Hall sensors, which detect variations in the magnetic field from the magnet attached to the lever end.

Other suitable detector elements may be alternatively used, such as an optical element, switches, etc. In an embodiment in which a magnet is used as an emitting element,, the magnetic field emitted from the magnet may vary as the, position of the shift lever is varied, and this variation of the magnetic field is sensed by the Hall sensors in the electronic board. A command signal is then emitted to a transmission programmed electronic unit for remote gearchange.

Still in some embodiments of the shift-by-wire gearshift device of the invention, the detector element further includes a metal plate (e.g. a ferromagnetic plate) that is coupled with the electronic board for enhancing the magnetic field.

In some embodiments of the invention, the selector lever comprises a main shaft and a follower finger located at the lever end. The follower finger may be displaced axially relative to the main shaft as it passes over the contoured surface, that is, as the finger end is “reading” the surface, due to the action of the biasing element. The biasing element acts on the follower finger such that it is urged against the contoured surface. The biasing element may comprise, for example, a compression spring arranged outside and around the selector lever main shaft urging the follower finger downwardly against the contoured surface.

The follower finger is hollow so that the lower end of the selector lever main shaft may be inserted therein. Therefore, the shifting device may be fitted in standard levers only adapting finger and spring size to the lever main shaft outer diameter. By combining this along with an updated contoured surface (through a programmable software), the shifting device may be adapted to a wide variety of gearshift assemblies in most of the currently existing types of vehicles.

A high performance, improved shift-by-wire gearshift device is provided according to the invention, which may perform one or more of four main functions:
detecting the driver's wish;
informing a transmission programmed electronic unit about the driver's wish;
providing a haptically suitable shifting feeling to the driver corresponding to each position of the gearbox; and
detecting the lever position relative to the contoured surface

There is provided a long-lasting, robust gearshift device having a compact configuration since a fewer number of parts is used. This is achieved by providing a selector lever having built-in detector element so that the lever itself provides both the feeling and the detection features. A further advantage of the invention is the lower cost of the gearshift device since the detector element may be installed in standard selector levers as they are included in the selector lever tip, within the finger, which fits the lower portion of the lever.

### BRIEF DESCRIPTION OF THE DRAWINGS

A particular embodiment of a shift-by-wire gearshift device according to the present invention will be described in the following, only by way of non-limiting example, with reference to the appended drawings, in which:

FIG. 1 is an elevational view of one embodiment of a shift-by-wire gearshift device according to the invention;

FIG. 2 is sectional view of the shift-by-wire gearshift device in FIG. 1 taken along line A-A′ in FIG. 4;

FIG. 3 is sectional view of the shift-by-wire gearshift device taken along line B-B′ in FIG. 4;

FIG. 4 is a top plan view of the embodiment of the shift-by-wire gearshift device in the above figures; and

FIG. 5 is an enlarged view of the gearshift device shown in FIG. 3 in which the housing has been removed for clarity.

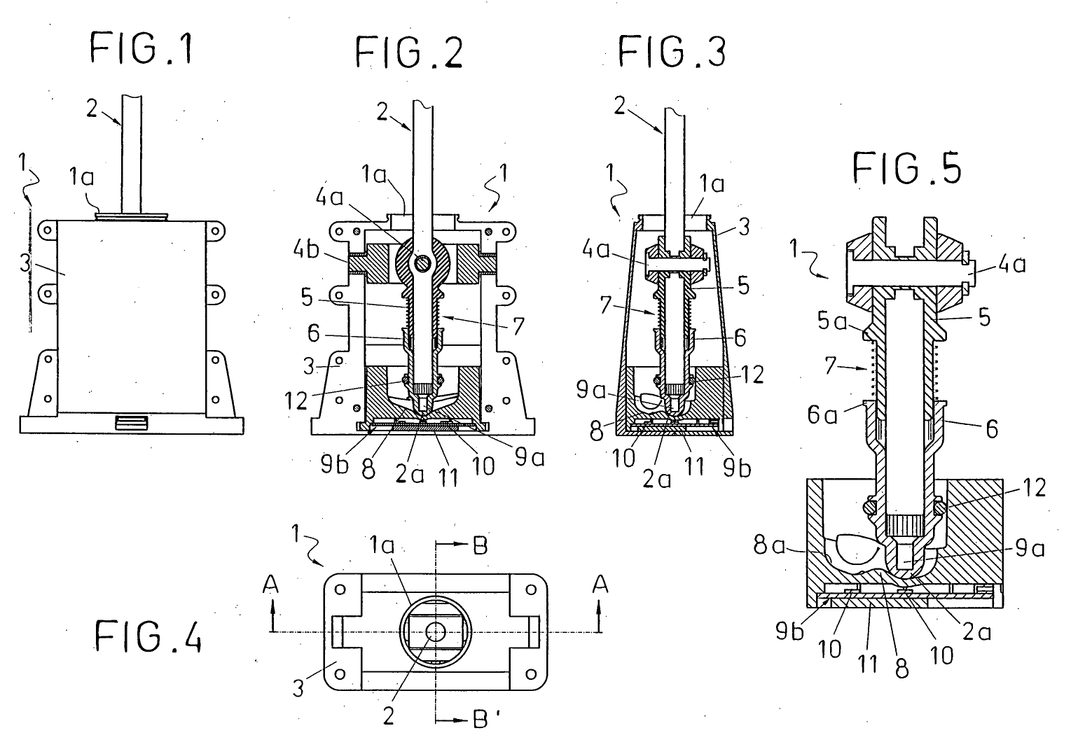

### DETAILED DESCRIPTION OF EMBODIMENTS

The shift-by-wire gearshift device of the embodiment shown in the figures has been indicated as a whole by reference numeral 1. It comprises a selector lever 2 having a main shaft 5 (partly shown in the figures) that is linked to a housing 3 through a crosspiece 4a, 4b. Crosspiece 4a, 4b consists of a first shaft 4a hinged transversely to the main shaft 5 of the selector lever 2 and a pivotable body 4b hinged transversely to the main shaft 5 and to the first shaft 4a. Of course, other mechanical linkages may alternatively be used, such as ball-joints or the like. The housing 3 has an upper opening 1a through which part of the selector lever 2 exits.

The selector lever 2 has a lower follower finger 6 fitted in the main shaft 5. The follower finger 6 may be clearly seen in the enlarged view of FIG. 5. The follower finger 6 is hollow so that the main shaft 5 may be properly inserted therein. The follower finger 6 may be displaced axially relative to the main shaft 5 of the lever 2. A biasing element 7 comprising a compression spring is provided between projections 5a, 6a that project out radially from the main shaft 5 and the follower finger 6, respectively. As stated above, the spring 7 is arranged between said projections 5a, 6a, outside and around the main shaft 5 of the selector lever 2 such that the spring 7 urges the follower finger 6 downwardly against a contoured surface 8 arranged at the bottom of the housing 1 in such a way that the selector lever tip 2a is always substantially in contact with said contoured surface 8. The contoured surface 8 is a 3D-relief surface having uneven grooves or channels 8a in which the selector lever tip 2a passes. This provides the user with a shifting feeling as the selector lever 2 is operated for remotely controlling the motor vehicle transmission.

The end portion of the follower finger 6 of the selector lever 2 is provided with a properly sized O-ring 12 working in compression for a proper end-of-travel feeling in each of the possible directions of the selector lever 2.

The shift-by-wire gearshift device 1 further comprises a detector element comprising an emitting element 9a and a receiving element 9b for detecting the position of the selector lever tip 2a on the contoured surface 8.

In the embodiment shown, the emitting element 9a comprises a magnet that is attached to the selector lever 5, for example overmolded within the selector lever tip 2a. The magnet 9a generates a magnetic field strong enough to be detected by the receiving element 9b.

The receiving element 9b comprises an electronic board that is fitted below the contoured surface 8, at the bottom thereof, such as shown in FIG. 5 of the drawings. The electronic board is provided with a series of Hall sensors 10 arranged at the bottom of the grooves or channels 8a of the contoured surface 8. Variations in the magnetic field as the position of the selector lever tip 2a is varied are detected by sensors 10. A command signal is then emitted to a transmission programmed electronic unit (not shown) for remote gearchange.

In the embodiment shown, the detector element further includes a metal plate 11, for example a ferromagnetic plate, that is coupled with the electronic board for enhancing the magnetic field from the magnet 9a.

Therefore, detector element (comprising the emitting and the receiving element 9a, 9b) works in combination with feeling means (provided by the selector lever tip 2a, the biasing element 7 and the contoured surface 8) when the selector lever 2 is operated by the user. Both feeling and detection functions are performed by the selector lever 2.

The above specification, examples and drawings provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet other embodiments without departing from the recited claims.

1. A shift-by-wire gearshift device comprising:
a selector lever operable by a user for remotely controlling a motor vehicle transmission,
a biasing element to maintain one end of said selector lever in contact with a contoured surface for providing the user with a shifting feeling, and
a detector comprising
an emitting element and a receiving element,
wherein one of said emitting element and receiving element is attached to said end of the selector lever such that the position of the end of the selector lever on said contoured surface can be detected.

2. A shift-by-wire gearshift device as claimed in claim 1, wherein the emitting element is fitted in said end of the selector lever.

3. A shift-by-wire gearshift device as claimed in claim 1, wherein said emitting element comprises a magnet.

4. A shift-by-wire gearshift device as claimed in claim 3, wherein said receiving element is an electronic board fitted adjacent to said contoured surface, said electronic board being provided with sensors which detect variations in the magnetic field from said magnet.

5. A shift-by-wire gearshift device as claimed in claim 4, wherein said detector element further includes a metal plate coupled with said electronic board for enhancing the magnetic field.

6. A shift-by-wire gearshift device as claimed in claim 1, wherein said contoured surface is a 3D-relief surface.

7. A shift-by-wire gearshift device as claimed in claim 1, wherein the selector lever comprises a main shaft and a follower finger, said finger being displaceable axially relative to said main shaft, and said biasing element acts on the follower finger such that the follower finger is urged against the contoured surface.

8. A shift-by-wire gearshift device as claimed in claim 1, wherein said biasing element comprises a compression spring.

9. A shift-by-wire gearshift device as claimed in claim 8, wherein the lower end of the selector lever main shaft may be inserted into the follower finger, said compression spring being arranged outside and around the selector lever main shaft urging the follower finger against the contoured surface.

10. A method of operation of a shift-by-wire gearshift device comprising:
maintaining one end of a selector lever of a shift-by-wire gearshift device in contact with a contoured surface to provide a user with a shifting feeling, and
detecting a position of one end of the selector lever of the shift-by-wire gearshift device.
